(19) United States
(12) Patent Application Publication
(10) Pub. No.: US 2007/0047942 A1
(43) Pub. Date: Mar. 1, 2007

(54) Auto-focusing device with voice coil motor for position feedback and method for using same

(75) Inventors: Chi Lone Chang, Jhudong Township (TW); Hua Chen Hsu, Jhubei City (TW); Paul C. P. Chao, Banciao City (TW)

Correspondence Address: TROXELL LAW OFFICE PLLC, SUITE 1404, 5205 LEESBURG PIKE, FALLS CHURCH, VA, 22041, US

(73) Assignee: PowerGate Optical Inc.

(21) Appl. No.: 11/266,268

(22) Filed: Nov. 4, 2005

(30) Foreign Application Priority Data
Aug. 25, 2005 (TW) 094129058

(51) Int. Cl. G03B 13/34

(52) U.S. Cl. 396/133

(57) ABSTRACT

An auto-focusing device with voice coil motor for position feedback comprises a lens holder, a sensor holder, a permanent magnet set, a yoke and a base. The lens holder holds a lens barrel and is wound around with at least two coils wound in opposite directions. The sensor holder holds an image sensor. The permanent magnet set includes at least two permanent magnets stacked together with opposing poles to form a multi-pole permanent magnet set. The permanent magnet set is furnished on the periphery of lens holder and corresponds to the two coils on lens holder. The permanent magnet set is disposed on the yoke to form a close-loop magnetism so as to increase the density of magnetic lines and the efficiency of magnetic force, save power consumption, and extend the service life of device.

### BACKGROUND OF INVENTION

1. Field of the Invention

The present invention relates to an auto-focusing device with voice coil motor for position feedback, more particularly an auto-focusing device having a voice coil motor on its auto-focus lens as power source and a magnetic sensor to detect the position of lens for position feedback during auto-focus of lens.

2. Description of the Prior Art

As shown in FIG. 1, a standard camera 1 comprises a lens set 11, an optical sensor 12 and a focusing mechanism (not shown in the figure). The lens set 11 forms an image on optical sensor 12 by refracting the light rays from an object. If the distance between lens set 11 and optical sensor 12 (back focal length, BFL) is fixed, the lens can only show clearly objects at its hyperfocal distance (e.g. 2-3 meters away). For the camera to shoot objects clearly at varying distances (for example at a close distance), the distance between lens set and sensor must be adjusted using a focusing mechanism.

To obtain clear images of objects at different shooting distances, the focusing mechanism of the camera must be able to automatically fine-tune the distance between lens set and optical sensor. Thus the precision positioning of lens in the process of focusing presents an important topic.

The precision positioning techniques employed by conventional auto-focus lens using stepping motor or servo motor as power source are relatively mature. But such mechanical auto-focus lens typically requires a large number of precision driving elements. Its design has the drawbacks of complicated mechanical configuration, time-consuming assembly, bulkiness and high cost. Most seriously, it consumes a large amount of power and generates considerable noise. For small-sized photographic devices, such as cellular phone, personal digital assistant (PDA) or notebook computer equipped with miniature camera, such bulky mechanical auto-focus lens is apparently not suitable.

Comparatively, lens using voice coil motor (VCM) as power source offers the advantages of less components, small size, and relatively low power consumption and low noise, and hence are more suitable for miniature camera. However as shown in FIG. 2, the hysteresis phenomenon existing between the input current (or voltage) and lens displacement in the conventional VCM-type auto-focus device creates difficulty in precision positioning. In the case of low-end camera where the requirement for image quality is not as demanding, this problem is tolerated as allowable error. But for high-end camera that has more stringent requirement for image quality, conventional technique employs optical position sensor for precision positioning of lens. Optical position sensor requires laser light, optical ruler and other elements that tend to jack up the price of camera and take more space, which runs counter to the industry trend of designing small, low-priced and high-quality camera.

### SUMMARY OF INVENTION

The primary object of the present invention is to provide an auto-focusing device with voice coil motor for position feedback, which uses a magnetic sensor to detect the lens position for position feedback during auto-focusing. The present invention features fewer components, simple configuration, small size, lower cost, positioning precision, and low noise.

Another object of the present invention is to provide an auto-focusing method using voice coil motor for position feedback, which achieves precision positioning by obtaining the functional expression between voltage detected by the magnetic sensor and lens position and using it to provide feedback of lens position during auto focusing.

Yet another object of the present invention is to provide an auto-focusing device with voice coil motor for position feedback, which uses an electromagnetic actuator formed by two coils and two stacked permanent magnets with opposing poles to drive the lens to engage auto-focusing. Such design increases the magnetic flux density, enables full utilization of the effective magnetic field of permanent magnet, increases drive efficiency, and saves power consumption.

### BRIEF DESCRIPTION OF THE DRAWINGS

For further understanding the objects, the characteristics, and the functions of the structures of the present invention, a detailed description matched with corresponding drawings are presented as follows.

FIG. 1 is a diagram showing the focusing principle of conventional lens.

FIG. 2 is a function graph of input current versus displacement of a conventional VCM-type auto-focusing device.

FIG. 3 shows the circuit diagram of a preferred embodiment of VCM-type auto-focusing device according to the invention.

FIG. 4 is an exploded view of a preferred embodiment of VCM-type auto-focusing device according to the invention.

FIG. 5 is a schematic diagram of the lens holder of the VCM-type auto-focusing device with coils wound around it according to the invention.

FIG. 6 is a diagram showing the magnetic action of VCM-type auto-focusing device according to the invention.

FIG. 7 is an external view of the flat spring plate according to the invention.

FIG. 8 is a diagram showing the relationship between voltage signal (eH) detected by a magnetic sensor used by the invention and external magnetic field (H).

FIG. 9 is a function graph of external magnetic force detected by a single-phase magnetic sensor used in the invention versus the position of sensor.

FIG. 10 shows the flow chart of method used in a preferred embodiment of auto-focusing method according to the invention to create the functional expression between voltage detected by a single-phase magnetic sensor and lens position.

FIG. 11 is a function graph of external magnetic force detected by a dual-phase magnetic sensor used in the invention versus the position of sensor.

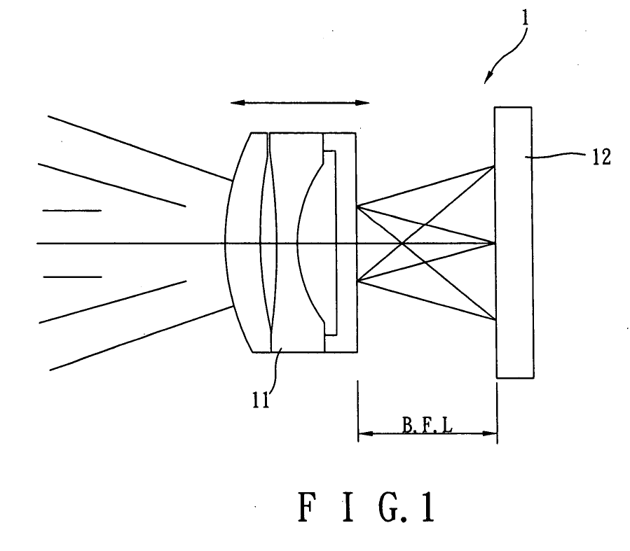

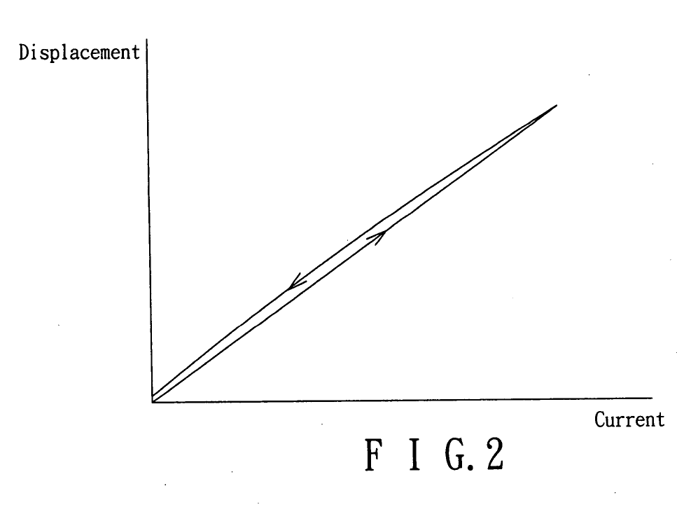

### DETAILED DESCRIPTION

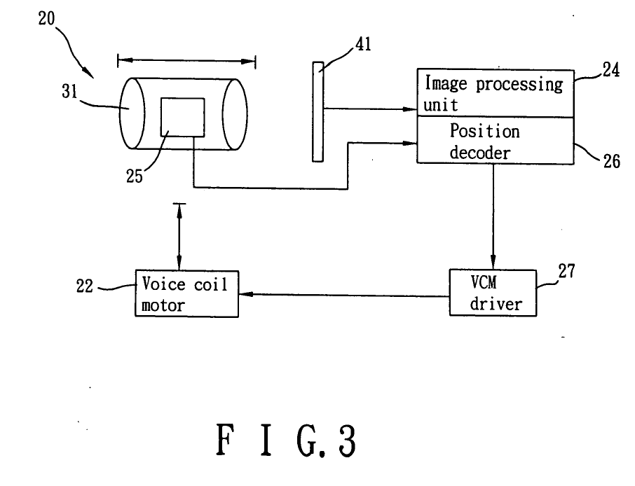

FIG. 3 shows the circuit diagram of a preferred embodiment of the auto-focusing device with voice coil motor for position feedback according to the invention. As shown, the auto-focusing device 20 comprises a lens barrel 31, a voice coil motor 22 (VCM), an image sensor 41, an image processing unit 24, a magnetic sensor 25, a position decoder 26, and a VCM driver 27.

The lens barrel 31 is an optical lens set consisting of a plurality of lenses, or in another preferred embodiment, a zooming lens set. The optical lens set and zooming lens set described are prior art and not one of the features of the invention. Thus their detailed constitution will not be elaborated below.

The voice coil motor 22 is attached to the lens barrel 31 and comprises coils and permanent magnets. It can electromagnetically drive the lens barrel 31 to engage in limited linear displacement, thereby adjusting the distance between lens barrel 31 and image sensor 41 to achieve the function of focusing. The voice coil motor 22 may be selected from currently known devices. Or the present invention further discloses a new voice coil motor 22, which drives lens barrel to engage in auto focusing through an electromagnetic actuator composed of two coils and two stacked permanent magnets with opposing poles. This newly invented voice coil motor 22 increases the magnetic flux density, allows full utilization of the effective magnetic field of permanent magnet, enhances drive efficiency, and saves power consumption. Its structure will be described in later sections.

The image sensor 41 is arranged opposite the lens barrel 31 which receives imaging light from lens barrel 31 and converts it into an image signal. In a preferred embodiment, the image sensor 41 is a charge-coupled device (CCD), a CMOS, or any element that can convert imaging light signal into electrical signal.

The image processing unit 24 is coupled to the image sensor 41 which receives the image signal and processes it into digital signal for reading by a computer. In this preferred embodiment, the image processing unit 24 also includes an auto-focus processing unit, which analyzes the clarity of image signal to determine whether to move the lens barrel 31 to perform focusing.

The magnetic sensor 25 is attached to lens barrel 31 and moves with it. The magnetic sensor 25 can sense the magnetic intensity and converts it into a voltage signal.

The position decoder 26 is coupled to the magnetic sensor 25, which receives the voltage signal, and based on which, detects the position of lens barrel 31 and feeds back the information during focusing operation.

The voice coil motor driver 27 is coupled to the voice coil motor 22, image processing unit 24 and position decoder 26, which, based on data on focus clarity and the position of lens barrel 31, outputs corresponding control signal to voice coil motor 22 to drive the movement of lens barrel 31 so as to achieve the function of focusing and enhance image clarity.

The present invention uses small-sized magnetic sensor 25 that takes little space to detect the position of lens barrel 31 for position feedback during auto-focusing. It practically uses no additional precision mechanical components or expensive optical positioning component, hence offering the advantages of fewer components, simple configuration, small size, lower cost, and positioning precision.

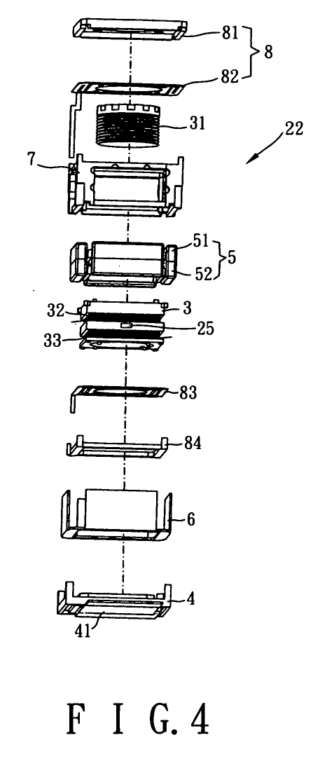

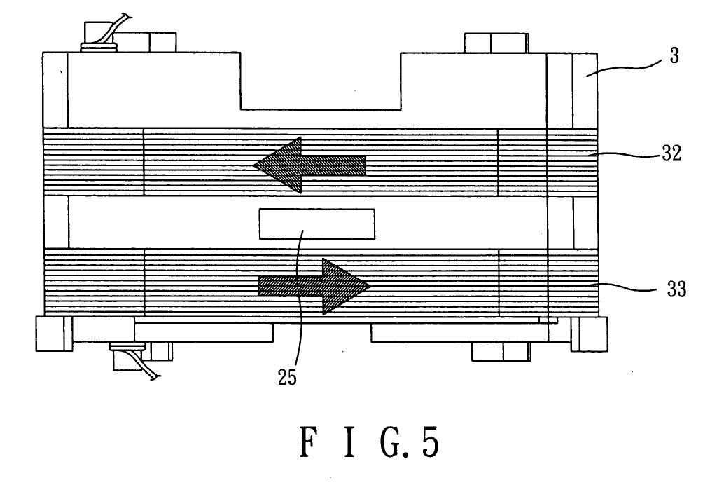

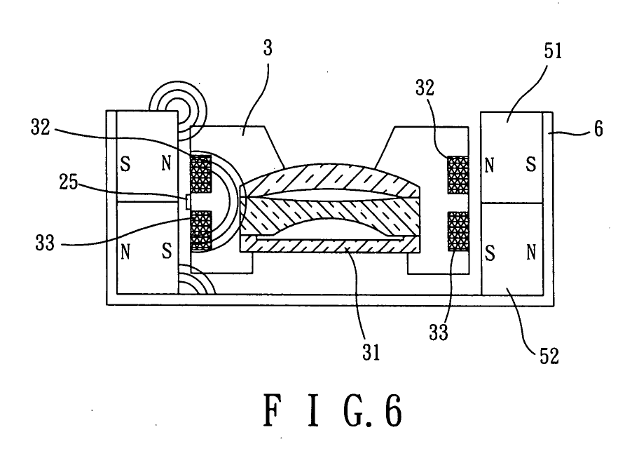

FIGS. 4, 5 and 6 show the structure of a preferred embodiment of the auto-focusing device with voice coil motor for position feedback according to the present invention that contains the newly invented voice coil motor 22. FIG. 4 is an exploded view of the auto-focusing device. FIG. 5 is a schematic diagram of the lens holder of the auto-focusing device with coils wound around it. FIG. 6 is a diagram showing the magnetic action of the auto-focusing device

As shown in FIG. 4, the voice coil motor 22 in the auto-focusing device in this embodiment comprises a lens holder 3, a sensor holder 4, magnets 5, a yoke 6, and a base 7. The lens holder 3 has a lens barrel 31 attached thereon and at least a first coils 32 and a second coils 33 wound on its periphery. The magnetic sensor is secured to the lens holder and arranged between the two coils, and moves together with the lens holder.

As shown in FIGS. 4 & 5, the adjacent first coils 32 and second coils 33 in this embodiment are wound in opposite directions. That is, when the first coils and the second coils are charged, their current directions are opposite to each other. The sensor holder 4 is mounted with a CMOS/CCD sensor 41 thereon to receive the imaging light from lens barrel 31. The magnets are made of at least a first magnet 51 and a second magnet 52 stacked together with opposing poles to form a multi-pole permanent magnet set 5. That is, the poles of the first magnet 51 and the second magnet 52 facing the lens barrel 31 are opposite to each other, rendering the upper half and lower half of the permanent magnet set 5 facing the lens barrel 31 to have opposing poles (as shown FIG. 6). The permanent magnet set 5 is disposed on the yoke 6 at the periphery of lens holder 3, and corresponds to the first coils 32 and second coils 33 located on lens holder 3. That is, the position of first magnet 51 essentially corresponds to that of first coils 32, and the position of second magnet 52 essentially corresponds to that of second coils 33.

When lens barrel 31 is about to shift position (i.e. to focus), a predetermined current is passed through the first coils 32 and the second coils 33 disposed on lens holder 3, enabling the coils to generate magnetic lines of force in specific directions. As a result, the magnetic action between first magnet 51 and second magnet 52 furnishes the force to push the lens holder 3 forward (as shown in the upper portion of FIG. 5) or backward (as shown in the lower portion of FIG. 5) along the axis of lens barrel 31. As such, the lens holder 3 holding the lens barrel 31 moves towards a predetermined direction to change the distance between lens barrel 31 and sensor 41 so as to achieve the purpose of focusing and zooming.

Referring to FIG. 6, through the structure described above, the first magnet 51 and the second magnet 52 of magnets 5 configured on yoke 6 can form a close-loop magnetism with the yoke 6 to increase the density of magnetic lines and improve the efficiency of magnetic action. Therefore in comparison with conventional devices, the present invention requires lower current to generate sufficient force to push and move the lens holder 31. It not only saves considerable power, but also effectively prolongs the standby or operating time of product under the same battery capacity, hence providing more convenience to users.

Again referring to FIG. 4, the lens holder 3 of the present invention further contains a shock-absorbing mechanism 8. The shock-absorbing mechanism 8 consists of a cover 81, a first spring 82, a second spring 83 and a base 84. The cover 81 and the base 84 are configured respectively at the top and bottom of lens holder 3 and securely adjoin to the base 7 of auto-focusing device. The first spring 82 is disposed between lens holder 3 and cover 81, while the second spring 83 is disposed between lens holder 3 and base 84. The first spring 82 and the second spring 83 of the shock-absorbing mechanism 8 configured respectively anterior and posterior to lens holder 3 provides adequate suspension and supporting force to suspend lens holder 3 therein. When the lens holder 3 engages in anterior or posterior displacement, or when lens holder 3 is under the impact of external force while staying at a fixed location, both the first spring 82 and second spring 83 in the shock-absorbing mechanism 8 provide a cushion to absorb the impact. The first spring 82 and second spring 83 are flat spring plate.

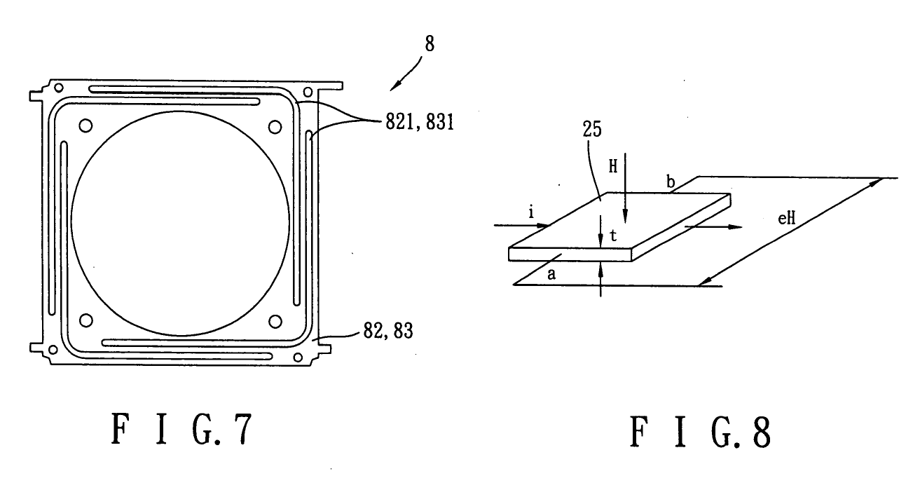

Referring to FIG. 7 which shows an external view of the flat spring plate, such spring plate features the arrangement of a plurality of long, hollowed-out slots 821, 831 on a flat piece with only a portion left for connection, where the restoring force of the spring provides the force needed for suspending and supporting lens holder 3. Even with other types of spring or spring plate, the present invention is able to reduce its overall volume, which represents excellent progress and contribution to miniaturization and enables it to be used by more products (e.g. notebook computer with built-in digital camera) to provide better focusing function.

FIG. 8 discloses the relation between voltage signal (eH) detected by the magnetic sensor 25 used by the invention and external magnetic field (H), that is, e_{H}=R_{H} i H/t, where e_{H} is the voltage detected, I is current value, H is the value of external electric field, and t is the thickness of magnetic sensor 25. From the relational expression above, it is clear that detected voltage (e_{H}) and external magnetic field (H) are directly proportional.

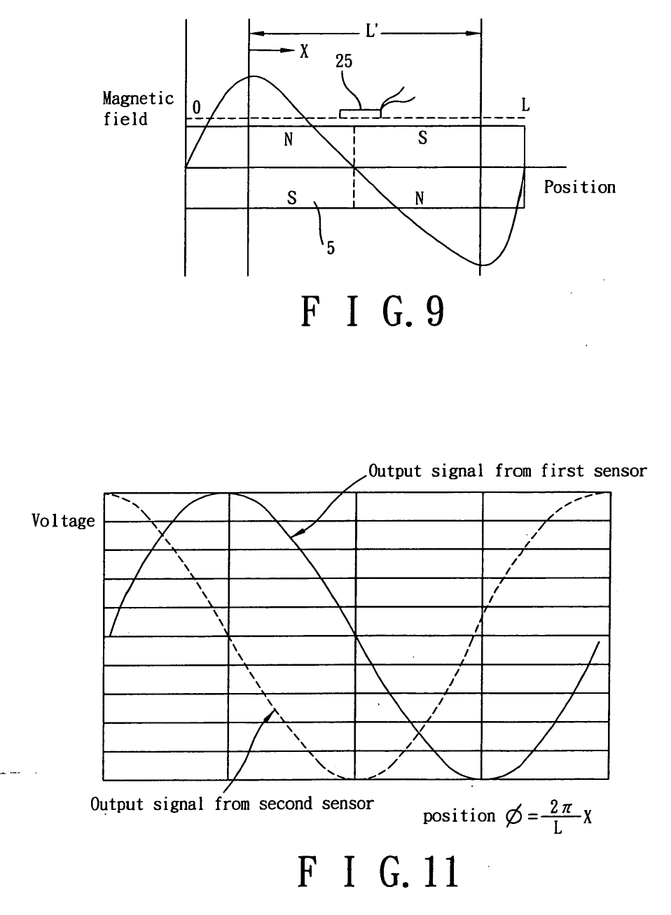

FIG. 9 is a function graph showing the relation between external magnetic force detected by a single-phase magnetic sensor used in the invention and the position of sensor. With the height between two poles of magnets 5 at L, the relationship between the magnetic flux density of actuation stroke L′ measured by a single-phase magnetic sensor 25 mounted on lens barrel and the vertical position of lens barrel is a linear function expressed in FIG. 9. Based on this linear function, the voltage measured by the single-phase magnetic sensor 25 may be converted to obtain the vertical position of lens barrel 31, which is then fed to the voice coil motor driver 27 to achieve the function of precision positioning.

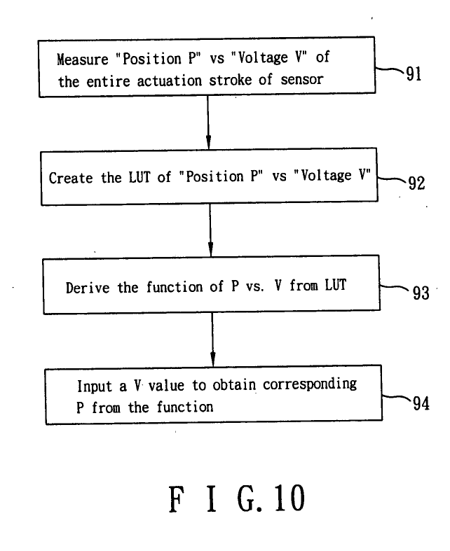

FIG. 10 shows the flow chart of method used in a preferred embodiment of auto-focusing method according to the invention to create the functional expression between voltage detected by the single-phase magnetic sensor and lens position. The method includes the following steps:

Step 91: Measure “position P” of magnetic sensor versus “voltage V” detected over the whole actuation stroke; use voice coil motor driver to move the lens barrel and magnetic sensor thereon back and forth over a predetermined stroke L′; in the process of displacement, record a plurality of known positions P of lens barrel and the plurality of corresponding voltages V detected by magnetic sensor.

Step 92: Create a “position P” and “voltage V” look-up table (LUT) based on the plurality of P and V values, which is the function graph illustrated in FIG. 9.

Step 93: Based on the “position P” and “voltage V” LUT, derive the functional relation between lens position P and voltage V as V=Ax+B, where 0<x<L′.

Step 94: Apply the aforesaid functional relation to calculate the position feedback of the auto-focusing device. That is, when lens barrel is driven to engage auto-focus, the voltage V detected by magnetic sensor is input into the functional expression to provide position feedback. It also means that the absolute position P (or phase) of lens barrel may be obtained by inputting voltage V detected by magnetic sensor at any position or phase into mathematical expression x=(V−B)/A.

FIG. 11 is a function graph of external magnetic force detected by a dual-phase magnetic sensor used in the invention versus the position of sensor. In a preferred embodiment that uses dual-phase magnetic sensor, the method for deriving the functional relation between the voltages detected by the dual-phase magnetic sensor and lens position includes the following steps:

First use the dual-phase magnetic sensor to measure the voltage throughout the 2 π cycle of the actuation stroke L to create a look-up table (LUT) of position P of dual-phase magnetic sensor and corresponding voltage (two sets of voltage signal V and V′ detected by the dual-phase sensor) as shown in FIG. 11, which is akin to two sine functions with phase difference of π2.

Next, mathematical expressions of V=AsinΦ, V′=AcosΦ are derived from the LUT, where Φ=(2π/L)x.

Through the aforesaid expressions, the correctΦof voltage V and V measured by the dual-phase magnetic sensor at any position P (or phase) may be confirmed, and the absolute position P (or phase) may be obtained through expression Φ=sin⁻¹(V/A), which circumvents the problem where sine function and position P (or phase) lack a one-to-one relationship.

It should be noted that the above described embodiments are not to be construed as limiting the applicable scope of the invention, but instead the protective scope of the invention should be defined by the technical spirit of the appended claims along with their full scope of equivalents. In other words, equivalents and modifications made based on the appended claims still accords with the intention of the invention and dose not depart from the spirit and scope of the invention. Thus, all should be regarded as further implementions of the invention.

What is claimed is:

1. An auto-focusing device with voice coil motor for position feedback, comprising:
a lens barrel;
a voice coil motor attached to the lens barrel and able to drive electromagnetically the lens barrel to engage in limited linear displacement;
an image sensor arranged opposite the lens barrel and able to receive imaging light from lens barrel and convert it into an image signal;
an image processing unit coupled to the image sensor and able to receive and process the image signal and analyze the focus clarity of image signal;
a magnetic sensor attached to the lens barrel and able to sense a magnetic intensity and convert it into a voltage signal;
a position decoder coupled to the magnetic sensor and able to receive voltage signal, and based on which, to detect the position of lens barrel; and
a voice coil motor driver coupled to the voice coil motor, image processing unit and position decoder, which, based on data on the focus clarity and the position of lens barrel, outputs a corresponding control signal to voice coil motor to drive the movement of lens barrel so as to achieve focusing and enhance focus clarity.

2. The auto-focusing device according to claim 1, wherein said voice coil motor comprises:
a lens holder attached with the lens barrel thereon and having at least two drive coils wound around its periphery with the adjacent coils wound in opposite directions; and
a permanent magnet set consisting of at least two permanent magnets stacked together with having opposite poles; the permanent magnet set is arranged on the periphery of lens holder and its two permanent magnets essentially correspond to the two coils;
wherein by passing a current through at least two drive coils, a predetermined magnetic force is generated to push the lens holder together with the lens barrel thereon to displace;
wherein said magnetic sensor is attached to the lens holder and arranged between the two drive coils, and displaces with the lens barrel.

3. The auto-focusing device according to claim 2, wherein said permanent magnet set contains at least a first permanent magnet and a second permanent magnet stacked together with opposing poles such that the poles of first permanent magnet and the second permanent magnet facing the lens barrel are opposite to each other, rendering the upper half and the lower half of said permanent magnet set facing the lens barrel to have opposing poles.

4. The auto-focusing device according to claim 2, wherein said voice coil motor further comprises:
a sensor holder having an image sensor attached thereon; and
a base formed with an opening thereon to accommodate the lens holder and allowing the assembly of permanent magnet set and sensor holder to be secured thereon.

5. The auto-focusing device according to claim 4, wherein said voice coil motor further comprises:
a yoke secured to the base and able to accommodate said permanent magnet set thereon to form a close-loop magnetism.

6. The auto-focusing device according to claim 4, wherein said lens barrel is further arranged with a shock-absorbing mechanism therein to provide cushioning effect.

7. The auto-focusing device according to claim 6, wherein said shock-absorbing mechanism consists of a cover, a first spring, a second spring and a base, the cover and the base configured respectively at the top and bottom of lens holder and securely adjoining to the base of auto-focusing device, the first spring disposed between the lens holder and the cover, and the second spring disposed between the lens holder and the base of shock-absorbing mechanism.

8. The auto-focusing device according to claim 7, wherein said first spring and said second spring are spring plate.

9. An auto-focusing method using voice coil motor for position feedback, comprising the steps of:
providing an auto-focusing device with voice coil motor which comprises at least a lens barrel, a voice coil motor for electromagnetically driving the movement of lens barrel, and a magnetic sensor attached to the lens barrel to measure the intensity of magnetic field and output a corresponding voltage signal;
using a voice coil motor to drive the lens barrel together with the magnetic sensor thereon to move back and forth within a predetermined distance, and in the course of movement, recording the plurality of known positions P of lens barrel and the plurality of corresponding voltage values V measured by the magnetic sensor;
deriving the functional expression between lens position P and voltage V based on the data on the plurality of lens position P and voltage V obtained;
applying said functional expression to calculation of position feedback that in subsequent driving of lens barrel to engage auto-focusing, the voltage V measured by magnetic sensor is input into the functional expression to obtain the position of lens barrel P, thereby providing the function of position feedback.

10. The auto-focusing method using voice coil motor for position feedback according to claim 9, wherein said auto-focusing device with voice coil motor further comprises:
an image sensor arranged opposite the lens barrel and able to receive imaging light from lens barrel and converts it into an image signal;
an image processing unit coupled to the image sensor and able to receive and process the image signal and analyze the focus clarity of image signal;
a position decoder coupled to the magnetic sensor and able to receive voltage signal, and based on which, to detect the position of lens barrel; and
a voice coil motor driver coupled to the voice coil motor, image processing unit and position decoder, which, based on data on the focus clarity and the position of lens barrel, outputs a corresponding control signal to voice coil motor to drive the movement of lens barrel so as to achieve focusing and enhance focus clarity.

11. The auto-focusing method using voice coil motor for position feedback according to claim 10, wherein said voice coil motor comprises:
a lens holder attached with the lens barrel thereon and having at least two drive coils wound around its periphery with the adjacent coils wound in opposite directions; and
a permanent magnet set consisting of at least two permanent magnets stacked together with opposite poles; the permanent magnet set is arranged on the periphery of lens holder and its two permanent magnets essentially correspond to the two coils;
wherein by passing a current through at least two drive coils, a predetermined magnetic force is generated to push the lens holder together with the lens barrel thereon to displace.
wherein said magnetic sensor is attached to the lens holder and arranged between the two drive coils, and displaces with the lens barrel.

12. The auto-focusing method using voice coil motor for position feedback according to claim 11, wherein said permanent magnet set contains at least a first permanent magnet and a second permanent magnet stacked together with opposing poles such that the poles of first permanent magnet and the second permanent magnet facing the lens barrel are opposite to each other, rendering the upper half and the lower half of said permanent magnet set facing the lens barrel to have opposing poles.

13. An auto-focusing method using voice coil motor for position feedback, comprising the steps of:
using a voice coil motor to electromagnetically drive a lens barrel to move between a predetermined distance;
using an image sensor to receive an imaging light from said lens barrel and convert it into an image signal, and using an image processing unit to analyze the focus clarity of said image signal;
using a magnetic sensor mounted on said lens barrel to measure the intensity of a magnetic field and convert it into a voltage signal;
using a position decoder to obtain the position of said lens barrel based on the voltage signal; and
based on the focus clarity of image and the position of lens barrel, using a voice coil motor driver to output a corresponding control signal to the voice coil motor and drive the movement of lens barrel so as to enhance focus clarity.

14. The auto-focusing method using voice coil motor for position feedback according to claim 13, wherein said voice coil motor comprises:
a lens holder attached with the lens barrel thereon and having at least two drive coils wound around its periphery with the adjacent coils wound in opposite directions; and
a permanent magnet set consisting of at least two permanent magnets stacked together with opposite poles; the permanent magnet set is arranged on the periphery of lens holder and its two permanent magnets essentially correspond to the two coils;
wherein by passing a current through at least two drive coils, a predetermined magnetic force is generated to push the lens holder together with the lens barrel thereon to displace.
wherein said magnetic sensor is attached to the lens holder and arranged between the two drive coils, and displaces with the lens barrel.

15. The auto-focusing method using voice coil motor for position feedback according to claim 14, wherein said permanent magnet set contains at least a first permanent magnet and a second permanent magnet stacked together with opposing poles such that the poles of first permanent magnet and the second permanent magnet facing the lens barrel are opposite to each other, rendering the upper half and the lower half of said permanent magnet set facing the lens barrel to have opposing poles.
